(19) United States
(12) Patent Application Publication
(10) Pub. No.: US 2003/0075343 A1
(43) Pub. Date: Apr. 24, 2003

(54) Dry sprinkler

(75) Inventor: Robert J. Ballard, Stephens City, VA (US)

Correspondence Address: LEYDIG VOIT & MAYER, LTD, 6815 WEAVER ROAD, ROCKFORD, IL, 61114-8018, US

(73) Assignee: National Foam, Inc., d/b/a Kidde Fire Fighting, Exton, PA

(21) Appl. No.: 09/986,239

(22) Filed: Oct. 22, 2001

(51) Int. Cl. A62C 37/08

(52) U.S. Cl. 169/37

(57) ABSTRACT

A dry sprinkler comprises a tubular body having a connector and a sprinkler head. The connector is adapted to be connected to the water pipe network of the fire suppression system and the sprinkler head is adapted to discharge water or other liquid suppressant. The tubular body defines a flow passage between the connector and the sprinkler head. First and second seals are arranged in spaced relation along the flow passage and contain an antifreeze fluid therebetween. The antifreeze fluid may be a liquid or gas subjected to pressure. A thermally responsive element is arranged to maintain the second seal in a state that contains the antifreeze fluid between the first and second seals. The thermally responsive element releases the second seal when an elevated temperature condition exists.

### FIELD OF THE INVENTION

The present invention relates generally to fire fighting apparatus, and more particularly relates to “dry sprinklers” which are typically installed in areas that are exposed to freezing conditions.

### BACKGROUND OF THE INVENTION

Dry sprinklers are used in areas that are exposed to freezing conditions, such as in freezers or walkways that may experience freezing conditions.

The typical construction of a dry sprinkler comprises a sprinkler head, a tube, a pipe connector at the inlet end of the tube (for connecting the inlet end to the pipe network of the fire suppression system), a plug seal at the inlet end to prevent water from entering the tube, and an actuating mechanism to maintain the plug seal at the inlet end. Typically, the tube section of prior art dry sprinklers is vented to the external atmosphere to allow drainage of water that can condense in the tube due to the environment in which dry sprinklers may operate (e.g. temperature fluctuations and/or humidity fluctuations). Such dry sprinklers according to this arrangement are generally disclosed in U.S. Pat. Nos. 5,775,431 to Ondracek and 5,967,240 to Ondracek. As shown generally in these patents, the actuating mechanism is a rod or other similar structure that extends through the tube between the sprinkler head and the inlet end to maintain the seal at the inlet end. The actuating mechanism includes a thermally responsive support element that supports the rod and therefore the seal at the inlet end. When an elevated temperature is experienced, the thermally responsive support element fails releasing the plug seal to allow water to flow through into the tube to the sprinkler head.

There are several drawbacks associated with prior attempts of dry sprinklers. One such problem as expressly recognized in the '431 and '240 patents is that internal actuating mechanisms can interfere with and impede the flow of water suppressant to the sprinkler head. While the '431 and '240 patents are asserted to reduce these flow interference problems, such internal actuating mechanisms still act on the flow water and can cause such interference. Moreover, corrosion of the metal in dry sprinklers can inevitably occur overtime and may also interfere with proper sprinkler operation.

### BRIEF SUMMARY OF THE INVENTION

In light of the above, it is a general aim of the present invention to provide a more reliable dry sprinkler for a fire suppression system.

In that regard, it is also an object of the present invention to provide a commercially feasible dry sprinkler that is relatively inexpensive and competitive in the marketplace.

According to one aspect of the present invention, it is an object to reduce corrosion of dry sprinklers.

In accordance with these and other objectives, the present invention is directed toward a dry sprinkler in which two seals are provided to seal the inside of the apparatus from the external atmosphere. An antifreeze fluid such as pressurized gas or a liquid subjected to pressure is contained inside the dry sprinkler between seals. The seals and antifreeze provide advantages such as a reduction in corrosion inside of the dry sprinkler and that the internal actuating mechanism structures of prior dry sprinklers may be eliminated if desired.

A dry sprinkler according to the invention comprises a tubular body having a connector and a sprinkler head. The connector is adapted to be connected to the fire suppression system and the sprinkler head is adapted to discharge liquid suppressant when in operation. The tubular body defines a flow passage between the connector and the sprinkler head. First and second seals are arranged in spaced relation along the flow passage and contain an antifreeze fluid therebetween. A thermally responsive element is arranged to maintain the second seal in a state that contains the antifreeze fluid between the first and second seals. The thermally responsive element releases the second seal when an elevated temperature condition exists.

According to an operational aspect of the invention, when the second seal is released, the antifreeze fluid escapes from the tubular body and no longer acts upon the first seal such that the first seal is adapted to be opened by pressure of liquid suppressant and adapted to allow liquid suppressant to flow through the flow passage to the sprinkler head.

Other objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a cross section of a dry sprinkler according to a preferred embodiment of the present invention in a standby state.

FIG. 2 is a cross section of the dry sprinkler of FIG. 1, illustrated in operational state.

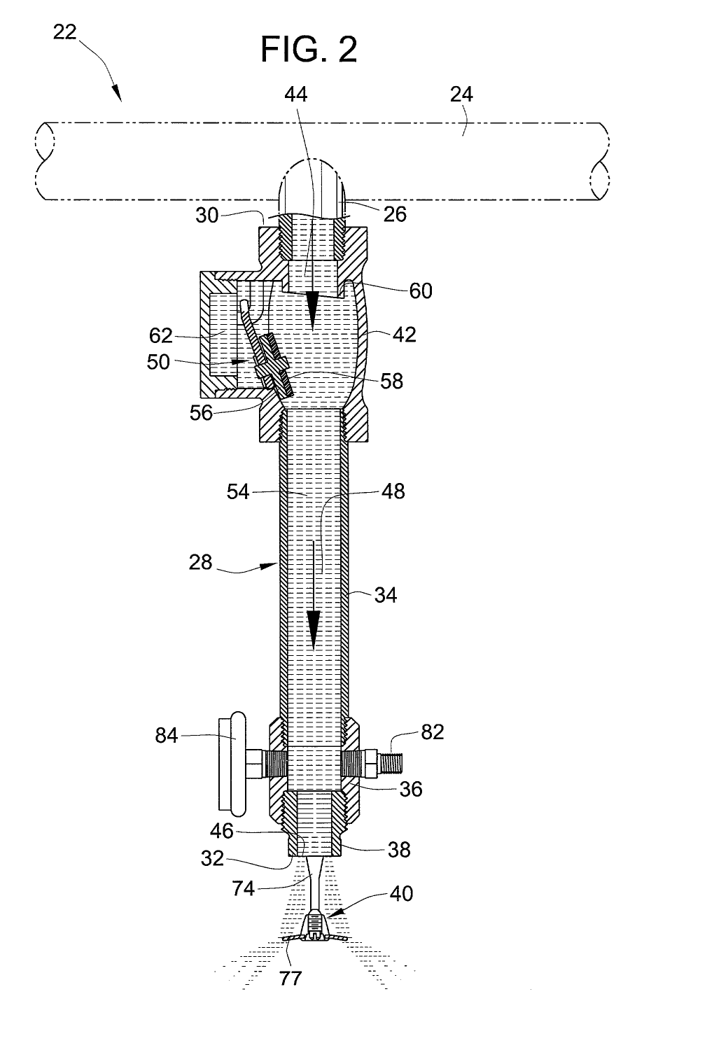

FIG. 3 is a cross section of an enlarged view of a portion of the sprinkler of FIG. 1 that has been rotated 90°.

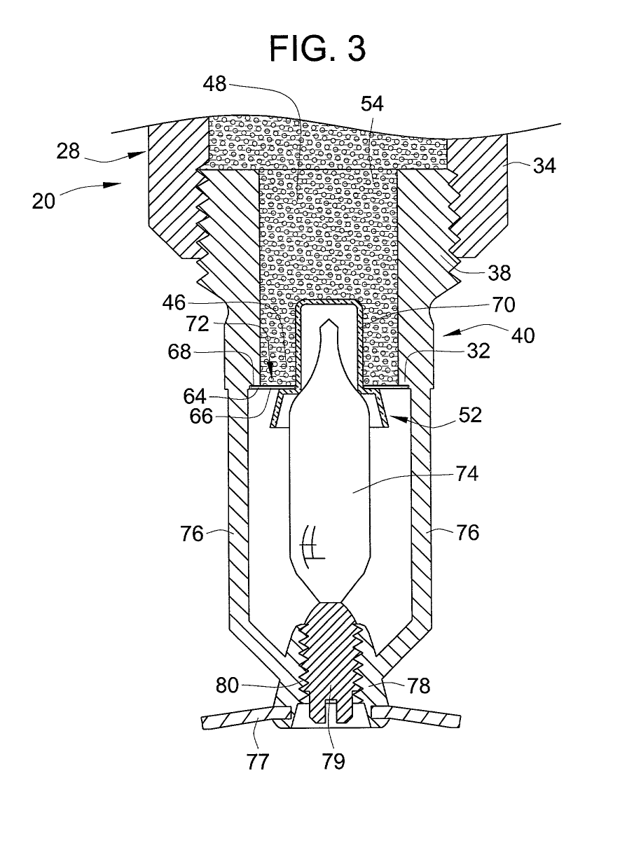

FIG. 4 is a side view of the dry sprinkler illustrated in FIG. 1 that has been rotated 90°.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

For purposes of illustration, the present invention has been depicted as a dry sprinkler 20 shown in the environment of a fire suppression system 22. The fire suppression system includes a pipe network 24 for transmitting water or other liquid fire suppressant to one or more dry sprinklers 24. Each dry sprinkler 20 mounts onto a branch outlet pipe 26 extending from the pipe network 24. The sprinkler 20 projects from the outlet pipe 26 into areas that may be subject to freezing conditions.

The sprinkler 20 includes a tubular body 28 extending between an inlet end 30 and an outlet end 32. The tubular body 28 may be constructed of metal with a single component or several components or portions of several components. In the disclosed embodiment, the tubular body 20 includes several components threadingly connected, including a central pipe 34, a pipe/sprinkler adapter 36, the pipe fitting 38 of a sprinkler head 40, and an inlet pipe adapter 42. The sprinkler 20 includes an inlet port 44 at the inlet end 30 and an outlet port 46 at the outlet end 32. The sprinkler 20 generally defines an internal cavity or flow passage 48 extending from the inlet port 44 to the outlet port 46 for transmitting water to the sprinkler head 40 in the event of a fire.

In accordance with the present invention, the disclosed sprinkler 20 includes a pair of spaced apart seals in the form of a check valve 50 at the inlet end 30 and a release plug 52 at the outlet end 32. The check valve 50 and the release plug 52 contain an antifreeze fluid 54 inside the sprinkler 20 along the flow passage 48.

The antifreeze fluid 54 is a fluid that will not freeze or cause condensation of water that could damage or impede operation of the sprinkler 20. Suitable antifreezes include gases such as: nitrogen, carbon dioxide, conditioned/dehydrated compressed air or other suitable gas that does not cause corrosion or frost that would damage or impede operation of either of the seals. Suitable antifreezes also include liquids such as proportional mixtures of water and one of the following antifreeze chemicals: Glycerin, Propylene Glycol, Diethylene Glycol, Ethylene Glycol, Calcium Chloride, or other that does not cause corrosion or frost that would damage or impede operation of either of the seals. Liquid antifreezes substantially fill the flow passage but may be subject to pressure via a pocket of pressurized gas. Preferably, the antifreeze fluid 54 is selected to have a characteristic of being generally non-combustible so as not to add fuel to a fire when the sprinkler 20 is operated.

In the disclosed embodiment, the check valve 50 is situated in the inlet pipe adapter 42 to form a back-flow prevention device. The check valve 50 comprises a pivoting valve member 56 having a sealing disc 58 of resilient material that is adapted to engage a circular valve seat 60 that surrounds the inlet port 44. A spring (not shown) may be used to bias the valve member 56 against the valve seat 60. The check valve 50 can be installed through a side opening 62 that is subsequently plugged. Although one form of check valve is illustrated, it will be appreciated that other forms of check valves both of the spring biased and unbiased type may alternatively be used. Additionally, it is also possible to use a rupture sealing plug or other sealing mechanism at the inlet end 30.

It will be appreciated that alternate seal structures at the outlet end 32 may also be used. However, in the disclosed embodiment the release plug 52 comprises a support structure such as a belleville washer 64 having a teflon or other suitable resilient sealing material layer or coating 60 that is adapted to engage a seal seat 68 surrounding the outlet port 46. The coating 60 may also be on the outlet end 32. The Belleville washer 64 includes a receptacle portion 70 and a disc shaped flange portion 72. The receptacle portion 70 receives a thermally responsive element 74 that is supported by the sprinkler head 40. The thermally responsive element 70 is a support structure made of a material that fails or melts at a predetermined elevated temperature. The flange portion 72 is seated on the seal seat 68 which may comprise a cylindrical/disc shaped cut-out portion surrounding the outlet port 46 for radial alignment and radial retention of the flange portion 72 of the release plug 72.

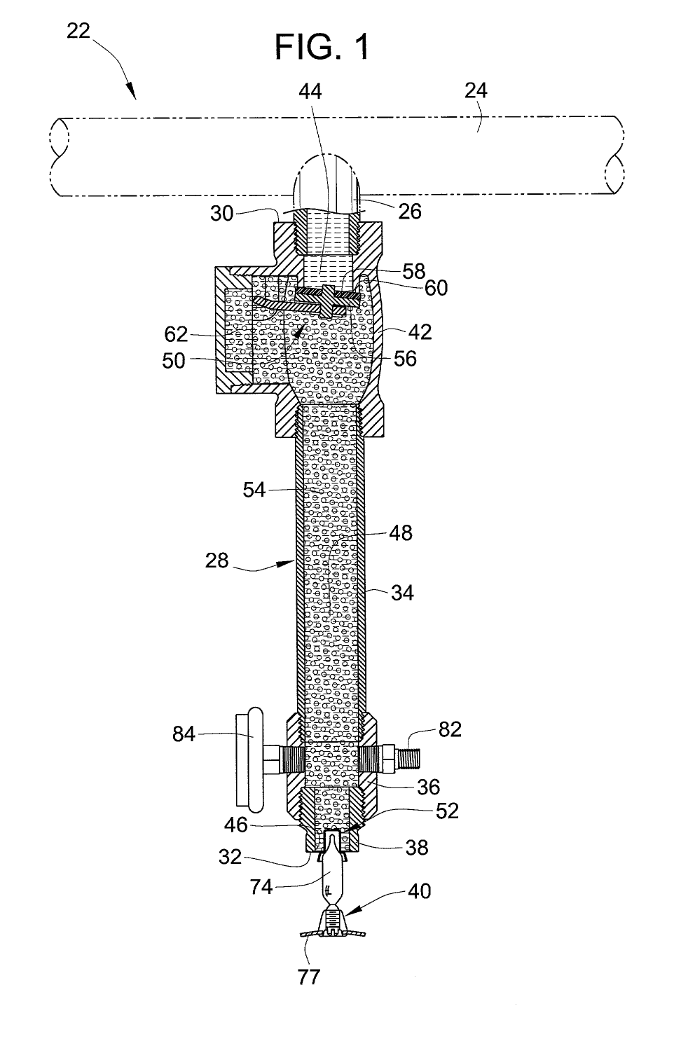

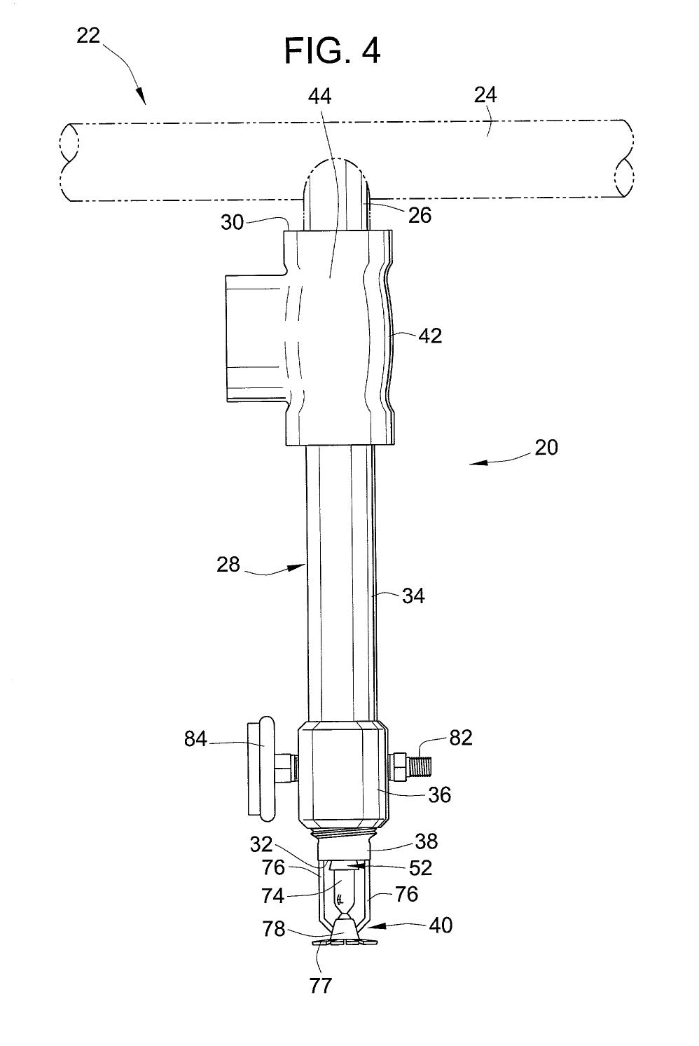

Turning in greater detail to the sprinkler head 40 and thermally responsive element 74, reference can be had to FIG. 1. The sprinkler head 40 includes a pair of curved arms 76 (See FIG. 4) projecting away from the outlet port 46 and toward each other to support a plate shaped deflector 77. The deflector 77 is adapted to deflect water radially outwardly into a fan shaped spray trajectory or other appropriate spray pattern as is desired for extinguishing fires in the particular application. The deflector 72 includes a threaded stem portion 79 that is threaded into a threaded hole 80 formed into the intersection 78 of where the arms 76 meet. The stem portion 79 projects through the hole 80 and urges the thermally responsive element 74 against release plug 52 to load the belleville washer 64 of the release plug 52 to ensure proper sealing relation between the flange portion 72 and the seal seat 68. The stem portion 79 can be tightened to adjust the force applied to the belleville washer 64 as desired. The belleville washer 64 stores the force or load imposed thereon to keep the flange portion 72 in sealing relation with the seal seat 68.

The sprinkler 20 may also include a bleed valve 82 and pressure sensor or pressure gauge 84 in communication with the internal flow passage 48 of the sprinkler 20. In the disclosed embodiment, these components are mounted to the sprinkler head adapter 36. The pressure gauge 84 provides a readout of the pressure inside the sprinkler 20. The antifreeze fluid 54 is contained at or subject to a pressure in a preferred range of between 200 PSI and 7 PSI, and more preferably between 110 PSIG and 50 PSIG, at room temperature, 25° C. Although a preferred range is given, it will be appreciated that the actual pressure may vary and can depend upon the particular fire suppression system 22 and design of the sprinkler 22. The bleed valve 82 is operable to relieve excess pressure from the flow passage 48 and may also be used during antifreeze fluid filling operations.

In the disclosed embodiment, the antifreeze fluid 54 is filled into sprinkler 20 through the check valve 50 at the inlet end 30. The bleed valve 82 may be opened initially during antifreeze filling operations to release air, moisture or other potentially undesirable contents inside the sprinkler 20. After the bleed valve 82 is closed, the antifreeze fluid 54 is filled or pressurized to the desired pressure. In the disclosed embodiment, the pressure of the antifreeze fluid 54 should be sufficient to apply a force against the check valve 50 to keep the check valve 50 closed to prevent water or other liquid fire suppressant from entering through the inlet port 44. A spring (not shown) may be used in the check valve 50 to decrease the necessary pressure of the antifreeze fluid 54. The load applied by the thermally responsive element 74 and stored belleville washer 64 or other suitable spring mechanism is sufficient to maintain a seal between the flange portion 72 and the seal seat 68 (through the teflon coating 66) and thereby prevent leakage of antifreeze fluid 54 from the flow passage 48. Under normal environmental conditions, the seals at the inlet end and the outlet end are maintained containing the antifreeze fluid in the flow passage 48.

In the event of a fire or other high temperature condition, the thermally responsive element 74 will fail or otherwise be caused to fail thereby relieving the load on the belleville washer 64. The pressure inside the sprinkler 20 will then push the release plug 52 away from the outlet port 46 allowing the antifreeze fluid 54 to discharge through the outlet port 46. The release plug 52 and the remnants of the thermally responsive element 74 are blown out and/or sprayed out of the sprinkler head 40 away from the deflector 77. As the pressure of the antifreeze fluid 54 is rapidly relieved through the outlet port 46, the closing pressure applied against the check valve 50 rapidly diminishes allowing water pressure in the pipe network 24 to push open the check valve 50 and allow flow of water into the sprinkler 20 along the flow passage 48 and then out through the outlet port 46 to be deflected as desired by the deflector 77 and then discharged over an area to suppress a fire or high temperature condition.

Although one form of sprinkler 20 is illustrated, it will be appreciated that the invention is applicable to standard or special automatic sprinklers and nozzles (such nozzle and sprinkler head variations referred to herein collectively as “sprinkler heads”). Sprinkler types can be classified as being upright, pendent, and sidewall and may also be recessed. All of these possibilities are intended to be covered by the claims appended hereto. The K-factor of the sprinkler 20 may range from 1 to 50 with a more preferably range of 3 to 30 and the most preferred range from 5.6 to 25.2. As is known in the art, the K-factor is a discharge coefficient which is equal to a volume divided by the square root of the pressure over a unit of area such as the equation K=Q/√P where Q is equal to the volume of flow such as gallons or liters per minute and P is the pressure usually given in pounds to square inch (psi) or in bar. The inlet pipe thread size of the sprinkler 20 typically ranges from ¼ inch to 3 inches, and more preferably ½ inch to 2 inches, and most preferably 1 inch.

All of the references cited herein, including patents, patent applications, and publications, are hereby incorporated in their entireties by reference.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A dry sprinkler for a fire suppression system for spraying liquid suppressant, comprising: a tubular body having a connector and a sprinkler head, the connector adapted to be connected to the fire suppression system, the sprinkler head adapted to discharge liquid suppressant, the tubular body defining a flow passage between the connector and the sprinkler head, further comprising first and second seals in spaced relation along the flow passage, wherein an antifreeze fluid is contained between the first and second seals, further comprising a thermally responsive element arranged to maintain the second seal in a state that contains the antifreeze fluid between the first and second seals, the thermally responsive element releasing the second seal when an elevated temperature condition exists.

2. The dry sprinkler of claim 1 wherein when the second seal is released, the antifreeze fluid escapes from the tubular body and no longer acts upon the first seal such that the first seal is adapted to be opened by pressure of liquid suppressant and adapted to allow liquid suppressant to flow through the flow passage to the sprinkler head.

3. The dry sprinkler of claim 1 wherein the antifreeze fluid is a liquid substantially filling the flow passage to act upon the first seal sufficiently to prevent pressure of liquid suppressant from opening the first seal when the dry sprinkler is mounted to the fire suppression system.

4. The dry sprinkler of claim 1 wherein the antifreeze fluid is a pressurized gas, the pressurized gas being pressurized sufficiently to provide a force acting upon the first seal to prevent pressure of liquid suppressant from opening the first seal when the dry sprinkler is mounted to the fire suppression system.

5. The dry sprinkler of claim 1 further comprising a pressure sensor mounted to the tubular body sensing pressure of the antifreeze fluid contained in the flow passage.

6. The dry sprinkler of claim 1 further comprising a bleed valve mounted to the tubular body and fluidically connected to the flow passage, the bleed valve operable to bleed antifreeze fluid from the flow passage to outside of the tubular body.

7. The dry sprinkler of claim 1 wherein flow passage is adapted to discharge liquid suppressant through an outlet port, the sprinkler head comprises first and second arms extending away from the outlet port, the first and second arms meeting at a threaded opening, the sprinkler head including a deflector, the deflector including a stem portion threaded into the threaded opening, the stem portion urging the thermally responsive element against the second seal.

8. The dry sprinkler of claim 7 further comprising a recessed seat formed into the second end surrounding the outlet port, the first seal having a receptacle portion receiving the stem portion and a radially outwardly projecting flange portion engaging the recessed seat.

9. The dry sprinkler of claim 8 wherein the second seal comprises a belleville washer, a coating of resilient sealing material disposed between the recessed seat and the belleville washer to seal therebetween..

10. The dry sprinkler of claim 1 wherein the first seal is provided by a check valve arranged to prevent flow of antifreeze fluid through the inlet port.

11. A dry sprinkler for a fire suppression system for spraying liquid suppressant, comprising:
a tubular body having an inlet port at a first end and an outlet port at a second end, the tubular body providing a flow passage extending between the inlet port and the outlet port;
a connector at the first end adapted to connect the dry sprinkler to the fire suppression system;
a sprinkler head at the second end, the sprinkler head having a deflector adapted to deflect the liquid radially outwardly;
a first seal closing the inlet port;
a second seal closing the outlet port;
an antifreeze fluid contained in the tubular body by the second seal, the antifreeze fluid acting upon the first seal and keeps the inlet port closed;
a thermally responsive element at the second end arranged to maintain the second seal in a position that closes the outlet port, the thermally responsive element releasing the second seal in response to an elevated temperature condition; and
wherein when the second seal is released, the antifreeze fluid escapes through the outlet port and no longer acts upon the first seal such that the first seal is adapted to be opened by pressure of liquid suppressant allowing liquid suppressant to flow through the flow passage to the sprinkler head.

12. The dry sprinkler of claim 11 wherein the antifreeze fluid is a liquid substantially filling the flow passage to act upon the first seal sufficiently to prevent pressure of liquid suppressant from opening the first seal when the dry sprinkler is mounted to the fire suppression system.

13. The dry sprinkler of claim 11 wherein the antifreeze fluid is a pressurized gas, the pressurized gas being pressurized sufficiently to provide a force acting upon the first seal to prevent liquid suppressant from opening the first seal when the dry sprinkler is mounted to the fire suppression system.

14. The dry sprinkler of claim 11 further comprising a pressure sensor mounted to the tubular body sensing pressure of the antifreeze fluid contained in the flow passage.

15. The dry sprinkler of claim 11 further comprising a bleed valve mounted to the tubular body and fluidically connected to the flow passage, the bleed valve operable to bleed antifreeze fluid from the flow passage to outside of the tubular body.

16. The dry sprinkler of claim 11 wherein the sprinkler head comprises first and second arms extending away from the outlet port, the first and second arms meeting at a threaded opening, the deflector including a stem portion threaded into the threaded opening, the stem portion urging the thermally responsive element against the second seal.

17. The dry sprinkler of claim 16 further comprising a recessed seat formed into the second end surrounding the outlet port, the first seal having a receptacle portion receiving the stem portion and a radially outwardly projecting flange portion engaging the recessed seat.

18. The dry sprinkler of claim 17 wherein the second seal comprises a belleville washer, a coating of resilient sealing material disposed between the recessed seat and the belleville washer to seal therebetween.

19. The dry sprinkler of claim 11 wherein the first seal is provided by a check valve arranged to prevent flow of antifreeze fluid through the inlet port.

20. A fire suppression system, comprising:
a supply of liquid suppressant;
a pipe network adapted to transport the supply liquid fire suppressant;
at least one dry sprinkler mounted to the pipe network extending from the pipe network into an area subjected to freezing conditions, each dry sprinkler comprising:
a tubular body having an inlet port at a first end and an outlet port at a second end, the tubular body providing a flow passage extending between the inlet port and the outlet port;
a connector at the first end connecting the dry sprinkler to the pipe network;
a sprinkler head at the second end, the sprinkler head having a deflector adapted to deflect the liquid radially outwardly;
a first seal closing the inlet port;
a second seal closing the outlet port;
an antifreeze fluid contained in the tubular body by the second seal, the antifreeze fluid acting upon the first seal and keeps the inlet port closed;
a thermally responsive element at the second end arranged to maintain the second seal in a position that closes the outlet port, the thermally responsive element releasing the second seal in response to an elevated temperature condition; and
wherein when the second seal is released, the antifreeze fluid escapes through the outlet port and no longer acts upon the first seal such that the first seal is opened by pressure of liquid suppressant allowing liquid suppressant to flow through the flow passage to the sprinkler head.

21. The fire suppression system of claim 20 wherein the antifreeze fluid is a liquid substantially filling the flow passage to act upon the first seal sufficiently to prevent pressure of liquid suppressant from opening the first seal.

22. The fire suppression system of claim 20 wherein the antifreeze fluid is a pressurized gas, the pressurized gas being pressurized sufficiently to provide a force acting upon the first seal to prevent liquid suppressant from opening the first seal.

23. The fire suppression system of claim 20 wherein each dry sprinkler further comprises a pressure sensor mounted to the tubular body sensing pressure of the antifreeze fluid contained in the flow passage.

24. The fire suppression system of claim 20 wherein each dry sprinkler further comprises a bleed valve mounted to the tubular body and fluidically connected to the flow passage, the bleed valve operable to bleed antifreeze fluid from the flow passage to outside of the tubular body.

25. The fire suppression system of claim 20 wherein the sprinkler head of each dry sprinkler comprises first and second arms extending away from the outlet port, the first and second arms meeting at a threaded opening, the deflector including a stem portion threaded into the threaded opening, the stem portion urging the thermally responsive element against the second seal.

26. The fire suppression system of claim 25 wherein the dry sprinkler further comprises a recessed seat formed into the second end surrounding the outlet port, the first seal having a receptacle portion receiving the stem portion and a radially outwardly projecting flange portion engaging the recessed seat.

27. The fire suppression system of claim 26 wherein the second seal comprises a belleville washer, a coating of resilient sealing material disposed between the recessed seat and the belleville washer to seal therebetween.

28. The fire suppression system of claim 20 wherein the first seal is provided by a check valve arranged to prevent flow of antifreeze fluid through the inlet port.

29. The fire suppression system of claim 20 wherein the liquid suppressant is water.
